(19) United States
(12) Patent Application Publication
(10) Pub. No.: US 2006/0070282 A1
(43) Pub. Date: Apr. 6, 2006

(54) Vehicle display panels

(75) Inventors: Lawrence Craig, Glasgow (GB); Joseph Blake, Glasgow (GB)

Correspondence Address: KIRKPATRICK & LOCKHART NICHOLSON GRAHAM LLP;(FORMERLY KIRKPATRICK & LOCKHART LLP), 75 STATE STREET, BOSTON, MA, 02109-1808, US

(73) Assignee: Spedian Limited, Glasgow (GB)

(21) Appl. No.: 11/151,637

(22) Filed: Jun. 13, 2005

Related U.S. Application Data
(63) Continuation-in-part of application No. 10/434,567, filed on May 9, 2003, now Pat. No. 6,904,709.

(30) Foreign Application Priority Data
May 10, 2002 (GB) 0210681.3
Sep. 19, 2002 (GB) 0221722.2

(51) Int. Cl. G09F 21/04

(52) U.S. Cl. 40/590

(57) ABSTRACT

A display panel and vehicle assembly, for example for advertising is described. The display panel is removably fastened to the vehicle around the around the majority of the perimeter of the flexible sheet and has a supplementary fastening arrangement having a first member fixed to the external surface of the vehicle, and a retaining member adapted to engage with the first member to retain the panel to the vehicle. An adapted vehicle, a vehicle and panel assembly, and a method of application are also described.

### CROSS-REFERENCE TO RELATED APPLICATIONS

This application is a continuation-in-part of U.S. patent application Ser. No. 10/434,567, filed May 9, 2003, and claims priority to United Kingdom Provisional Patent Applications GB 0210681.3, filed May 10, 2002 and GB 0221722.2, filed Sep. 19, 2002, the disclosures of which are herein incorporated by reference in their entirety.

### FIELD OF THE INVENTION

This invention relates to display panels mounted on vehicles, and in particular to improvements to the attachment of vehicle display panels.

### BACKGROUND OF THE INVENTION

In the field of advertising, the sides of trucks may be used to display advertising signs. Such mobile advertisements benefit advertisers with a useful advertising medium, and further benefit truck operators with an additional revenue source.

Advertising signs typically comprise printed PVC (poly vinyl chloride) sheets that are impervious to air and water. The sign may optionally further comprise reinforcements and fasteners.

Advertising signs on vehicles need to be prevented from catching air as the vehicle moves. The flow of air behind the sign can cause billowing, flapping and damage to or loosening of the sign.

One solution uses PVC sheets that are tensioned into a frame attached to the side of the truck. A PVC sheet, that has been digitally printed with an image, is unrolled and beading is fed into ridges around the edge of the sheet. The edge now containing the beading is fed into grooves along a frame attached to the side of the truck, and finally the sheet with beading is riveted securely into the frame.

U.S. Pat. No. 6,305,111 discloses an advertising display mounted on the side of a truck or any other substantially planar surface. The display includes an elastic display sign with four edges reinforced by stays. Attachment fittings are spaced along the edge of the supporting structure.

U.S. Pat. No. 6,167,649 discloses an information display system mounted on flat surfaces, such as the side of truck trailers, including a frame with a flexible sheet attached to the frame. There is an anchoring bracket rigidly attached to the side wall at each corner. Other anchoring brackets are attached at various locations along the sign's edges. The sign is a sheet of flexible plastic or cloth made from tightly woven natural or synthetic fibres.

The problems with these known approaches are the complicated and obtrusive nature of the fasteners attached (including by bolting) to the body of the vehicle. Furthermore, the advertising sheet itself requires complex adapting or attachment to a frame. All of these approaches use complex methods of engaging and tensioning the sheet.

Using a mesh sheet to allow more free airflow through the sign has the disadvantages of being difficult to print, having reduced quality of the printed image, being difficult to clean, having a tendency to stretch and the inability to add hidden fasteners around the centre of the image.

### SUMMARY OF THE INVENTION

In this document, the statement of invention and claims, a panel refers to the combination of a sheet with the fasteners affixed to it that enable the combination to be removably attached to a vehicle.

It would be advantageous to provide an advertising panel that can be attached to a vehicle without obtrusive fasteners, that can be easily removed and reapplied, and that does not require complicated fastener installation on the vehicle or in constructing the panel itself.

It would be advantageous to provide a supplementary fastening mechanism for an advertising panel, providing a more secure attachment when compared with the prior art.

It would be advantageous to provide a single use supplementary fastening mechanism for an advertising panel that provides a secure, locked attachment, and can subsequently be removed. It would be advantageous to provide a fastening mechanism for which removal is effected by damaging the mechanism, to prevent a fastening mechanism that has been used once, and could be degraded, from being used again.

It would be further advantageous to provide an advertising panel that is easy to clean, is held strongly in place, is non-permeable and that is sealed around at least part of its peripheral edge to inhibit air ingress between the panel and the truck while the truck is in motion.

It is an object of at least one aspect of the present invention to provide a means of attaching advertising panels to the side of vehicles wherein the panels are substantially airtight and easy to mount and remove.

According to a first aspect of the invention, there is provided a display panel and vehicle assembly, wherein the panel comprises a first fastener arrangement located around the majority of the perimeter of the panel, and the vehicle comprises a second fastener arrangement attached to an external surface of the vehicle, the first and second fastener arrangements configured to reclosably interlock with one another in use, wherein the assembly comprises a supplementary fastener arrangement comprising a first member fixed to the external surface of the vehicle, and a retaining member adapted to engage with the first member to retain the panel to the vehicle.

The supplementary fastener arrangement may be adapted to extend through an aperture provided in the panel.

Preferably, the first member includes a protruding stem adapted to extend through the aperture.

The protruding member may comprise a base providing a substantially planar surface to be fixed to the surface of the vehicle. The first member may be bonded to the surface of the vehicle.

The retaining member may comprise a formation adapted to receive the first member. The formation is a socket adapted to receive the stem. Preferably, the retaining member comprises a portion adapted to abut an outer surface of the panel. The retaining member may comprise a cap having a radial dimension greater than that of the aperture in the panel.

The first member and the retaining member and may be adapted to lock together. The first member and the retaining member may together comprise a ratchet-type locking mechanism.

The first member and the retaining member may be arranged such that, when locked together, they cannot be separated without damage to at least one of the first member and the retaining member.

The stem may have a main stem body profiled to provide a plurality of axially separated engaging formations extending outwardly from the main stem body.

The retaining member may be provided with formations for engaging with the engaging formations on the stem.

The retaining member may be manufactured from a plastic material. The plastic material may be transparent or translucent.

The panel may comply at least one reinforced member around the perimeter of the aperture. The reinforcing member may be a washer. The washer may be made from a plastic material. The washer may be bonded to the panel. The aperture in the washer may be dimensioned to fit the aperture on the panel. The panel may be provided with a pair of washers, located on either side of the panel and adapted to reinforce a single aperture.

According to a second aspect of the invention there is provided a method for attaching a display panel to a vehicle.

The invention also relates to a supplementary fastener arrangement for a vehicle and display panel assembly; an adapted vehicle, and an adapted panel.

According to a further aspect of the present invention, there is provided a display panel for use on an external surface of a vehicle, the display panel comprising a substantially non-permeable flexible sheet and at least one first fastening element attached around the majority of the perimeter of said flexible sheet and adapted to reclosably interlock with at least one second fastening element attached to said external surface of a vehicle.

According to a further aspect of the present invention, there is provided a vehicle and panel assembly, wherein the panel comprises at least one first fastening element arranged around the majority of the perimeter of said panel, the vehicle comprises at least one second fastening element attached to an external surface of the vehicle, the second at least one fastening element being adapted to reclosably interlock with said at least one first fastening element.

According to a further aspect of the invention, there is provided a vehicle adapted to receive a panel thereon, the vehicle comprising at least one fastening element attached to an external surface of the vehicle, the at least one fastening element being adapted to reclosably interlock with at least one corresponding fastening element arranged around the majority of the perimeter of said panel.

According to a further aspect of the invention, there is provided a method of mounting a display panel comprising a substantially non-permeable flexible sheet to a vehicle, the method comprising the steps of:
attaching at least one first fastening element to said flexible sheet around the majority of the perimeter of said flexible sheet;
attaching at least one second fastening element to an external surface of the vehicle, the external surface of the vehicle being oriented substantially in a surface plane; and
imparting a force to said first and second fastening elements in a direction substantially perpendicular to the surface plane.

According to a further aspect of the invention, there is provided a method of removing a display panel comprising a substantially non-permeable flexible sheet from a vehicle, the method comprising the steps of:
attaching at least one first fastening element to said flexible sheet;
attaching at least one second fastening element to an external surface of said vehicle; and
pulling said display panel perpendicular to the plane of the external surface of a vehicle.

Preferably said display panel is an advertising panel.

Typically said flexible sheet comprises a PVC coating.

Preferably said flexible sheet is printed on the side opposite to said at least one fastening element.

Preferably said fastening elements are adapted to reclosably interlock with another fastening element identical to said fastening element.

Alternatively, said first fastening element and said second fastening element are hook and loop fasteners.

Preferably said first fastening elements are arranged to match the position of corresponding second fastening elements on said external surface of a vehicle to form a corresponding pair of fastening elements.

Preferably said fastening elements are adapted to engage by pressing said fastening element perpendicular to the plane of said external surface of a vehicle.

Preferably said fastening elements are adapted to disengage by pulling said first fastening element perpendicular to the plane of said external surface of a vehicle.

Preferably said fastening elements comprise a substrate and a plurality of periodically spaced stems protruding perpendicularly from the substrate, each stem being symmetrical about the axis perpendicular to the substrate and having a first diameter at the distal end from the substrate greater than a second diameter at the end adjacent to said substrate.

A corresponding pair of first and second fastening elements may form a continuous strip.

In one embodiment, at least one gap is provided between two adjacent corresponding pairs of continuous first and second fastening elements. Preferably, the gap functions as a fluid outlet. More preferably, at least one fluid outlet is provided adjacent a downward facing edge of the panel.

Alternatively, or in addition, at least one fluid outlet is provided adjacent a rearward facing edge of the panel.

Preferably said first fastening element is adapted to reclosably interlock with a second fastening element such that on engagement there is an audible or tangible snap.

Preferably said first fastening element is attached to said flexible sheet by an attachment arrangement selected from a list of arrangements consisting of: bonding by adhesive, ultrasonic bonding, stitching and stapling.

Preferably said second fastening element is attached to said external surface of said vehicle by an attachment arrangement selected from a list of arrangements comprising: bonding by adhesive, ultrasonic bonding, stitching and stapling.

Optionally said display panel may be adapted to be further sealed substantially around the entire perimeter.

Preferably the display panel is further sealed by an adhesive tape.

Optionally the display panel is further sealed by a bead.

Optionally, a corner of the display panel may be further adapted to inhibit peeling of the corner.

Preferably the corner of the display panel is further adapted to inhibit peeling by a non-obtrusive adhesive patch.

### BRIEF DESCRIPTION OF THE DRAWINGS

In order to provide a better understanding of the present invention, a preferred embodiment will now be described by way of example only and with reference to the accompanying Figures, in which:

FIG. 1 illustrates in schematic form a truck trailer with fasteners attached and an advertising panel with corresponding fasteners attached in accordance with a preferred embodiment of the present invention;

FIG. 2a illustrates a truck trailer with an advertising panel attached in accordance with a preferred embodiment of the present invention;

FIG. 2b illustrates a truck trailer with an advertising panel attached and sealed by tape in accordance with another embodiment of the present invention;

FIG. 2c illustrates a truck trailer with an advertising panel attached and with the corners protected from peeling in accordance with another embodiment of the present invention;

FIG. 3 illustrates in schematic form a plan view of a fastener in accordance with a preferred embodiment of the present invention;

FIG. 4 illustrates in schematic form a section view of two disengaged fasteners in accordance with a preferred embodiment of the present invention;

FIG. 5 illustrates in schematic form two engaged fasteners in accordance with a preferred embodiment of the present invention;

FIG. 6 illustrates in schematic form a truck trailer with fasteners attached and an advertising panel with corresponding fasteners attached in accordance with an alternative embodiment of the present invention;

FIG. 7 is a side view of a truck trailer with supplementary fasteners; and

FIG. 8 is an exploded, sectional view through a supplementary fastener arrangement of FIG. 7.

### DETAILED DESCRIPTION OF THE ILLUSTRATIVE EMBODIMENTS

The invention relates to a panel, a vehicle, and a vehicle and panel assembly. In a further aspect the invention relates to a method that functions to attach the panel to the vehicle.

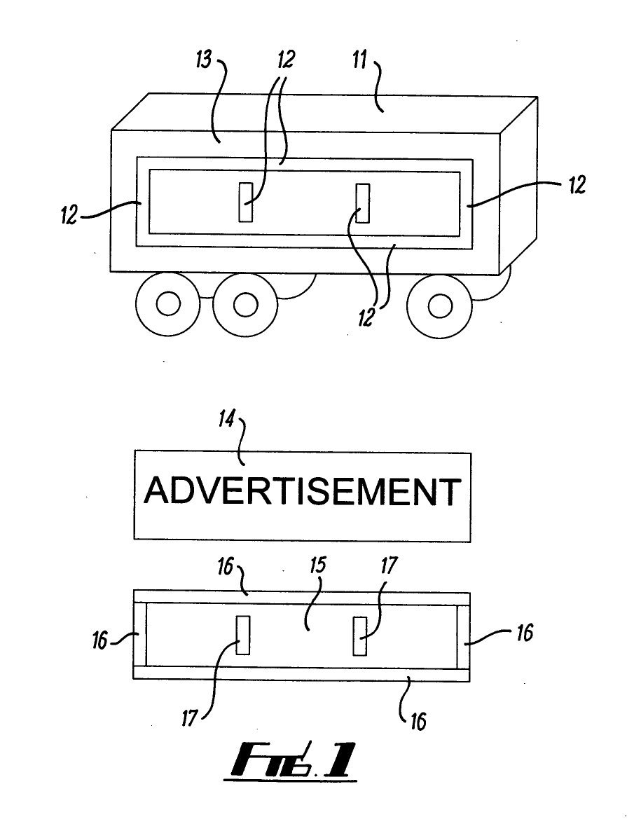

With reference to FIG. 1, the printed side of a display panel such as an advertising panel 14 is shown. Typically the panel has a sheet of PES (polyethersulfone) fabric coated on both sides with PVC with a matt lacquer applied to the printing side. The lacquer allows the panel to be printed. The sheet is UV stabilised, anti-wicking and fire retardant. The sheet is substantially non-permeable in that it does not allow liquid or air to readily pass through it.

The size of the sheet may vary to fit the size of the side of a trailer. The typical weight is approximately 460 g/m².

The reverse of the sheet 15 has strips of a fastener 16 attached, for example by bonding with glue, ultrasonic bonding, stapling or stitching. The strips are attached around substantially the entire perimeter of the sheet, in that there are substantially no gaps left for air or fluid ingress after mounting on the truck or truck trailer. Optionally, one or more fasteners 17 may be placed away from the perimeter in order to provide support for the centre of the sheet.

In the preferred embodiment of the present invention, 3M™ Dual Lock™ reclosable fastener is used. In an alternative embodiment a hook and loop reclosable fastener such as 3M™ Scotchmate™ may be used, with the hook fastener on either the panel or the vehicle.

The truck trailer 11 has corresponding fasteners 12 arranged on its side 13, attached for example by bonding with glue, ultrasonic bonding, stapling or stitching. Although a truck trailer is illustrated in the preferred embodiment, the panel may be mounted on any external surface of a vehicle.

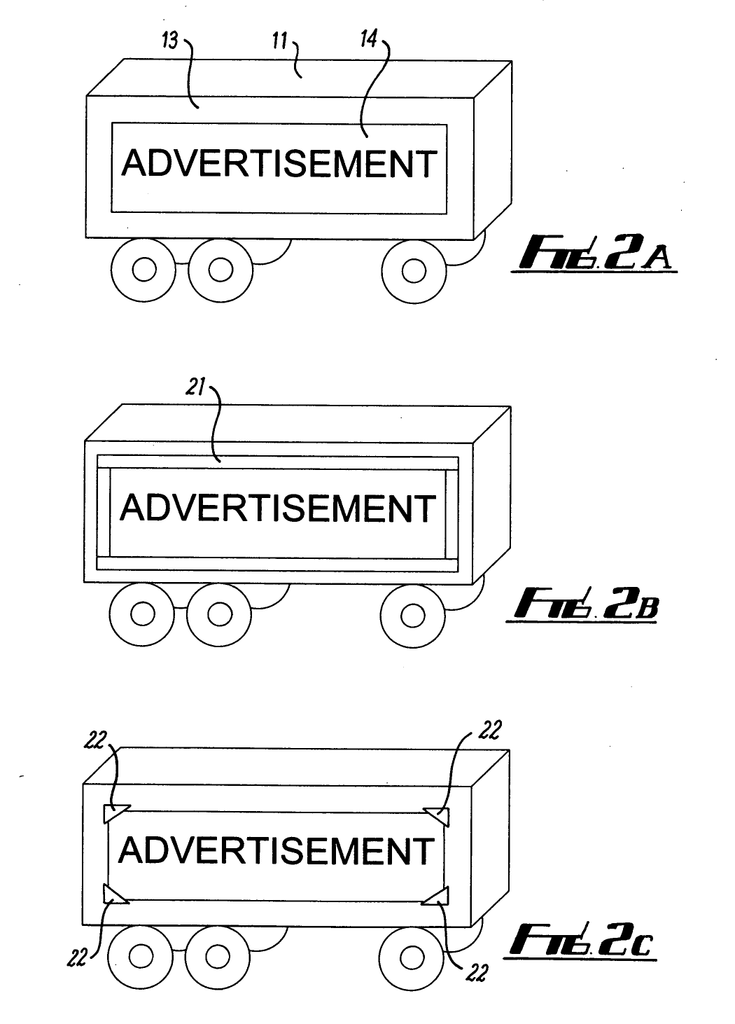

With reference to FIG. 2a, the advertising panel 14 is shown attached to the side 13 of the truck trailer 11, with the fasteners (that are shown in FIG. 1) on the panel 16 reclosably interlocked with the corresponding fasteners 12 on the side of the trailer.

In a further embodiment, with reference to FIG. 2b, the seal may be enhanced by the application of an adhesive tape 21 around the perimeter of the panel bridging the panel and the surface of the vehicle. In yet a further embodiment, a bead for sealing by contacting the panel and vehicle surface may be attached to the fastener or the panel or the vehicle around the perimeter of the panel.

In a further embodiment, with reference to FIG. 2c, the corners of the panel may be protected from unwanted peeling by the application of an adhesive patch 22 at one or more corners of the panel bridging the panel and the surface of the vehicle. For certain applications, alternative more obtrusive methods of securing the patch might be used to supplement the attachment. These may include riveting and securing with a padlock.

Although this preferred embodiment applies to advertising panels, any sign may be printed on to the panel, including for example, identification numbers and images for emergency vehicles and removable number patches for racing cars.

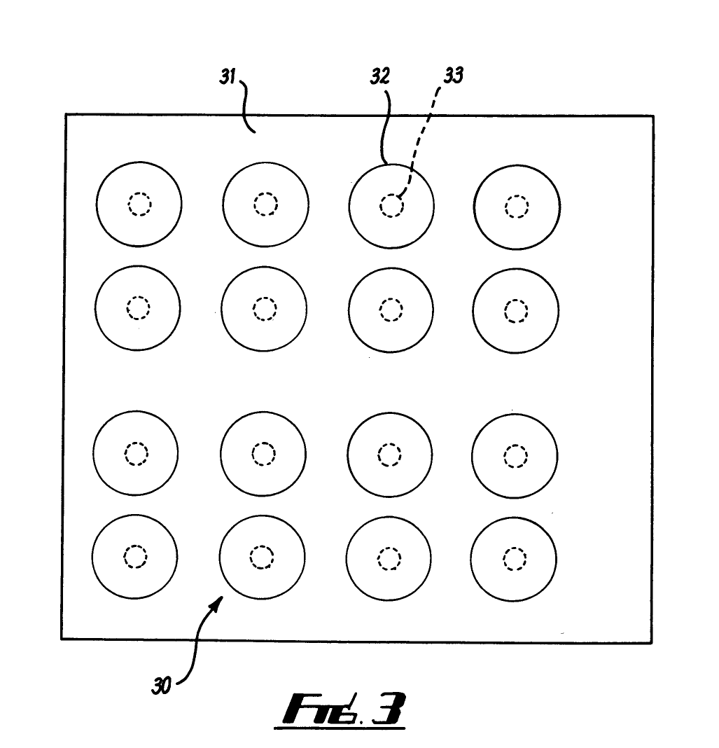

FIG. 3 shows a plan view of a section of the fastener used on both the panel and the side of the trailer in accordance with this preferred embodiment. An array of stems 30 protrude from a substrate 31. Each stem is symmetrical about the axis perpendicular to the substrate, and has a first diameter at the distal end from the substrate 32 greater than a second diameter at the end adjacent to the substrate 33 (this is shown in FIG. 3 as a dotted line indicating that it would not be visible directly in this plan view).

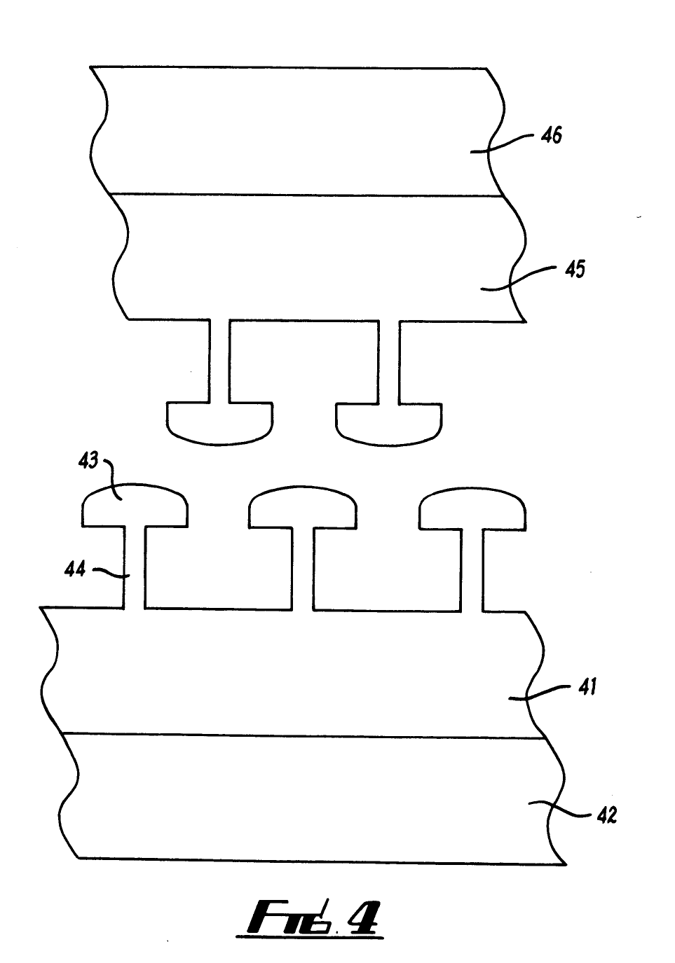

With reference to FIG. 4, a cross-section of two pieces of fastener is shown according to the preferred embodiment of the present invention. The first piece 41 is attached by bonding to the advertising panel 42. In cross-section, the first diameter of the stem at the distal end from the substrate 43 can be seen to be greater than the second diameter 44 of the stem at the end adjacent to the substrate. A second fastener 45 is attached to the side of the truck trailer 46 by bonding.

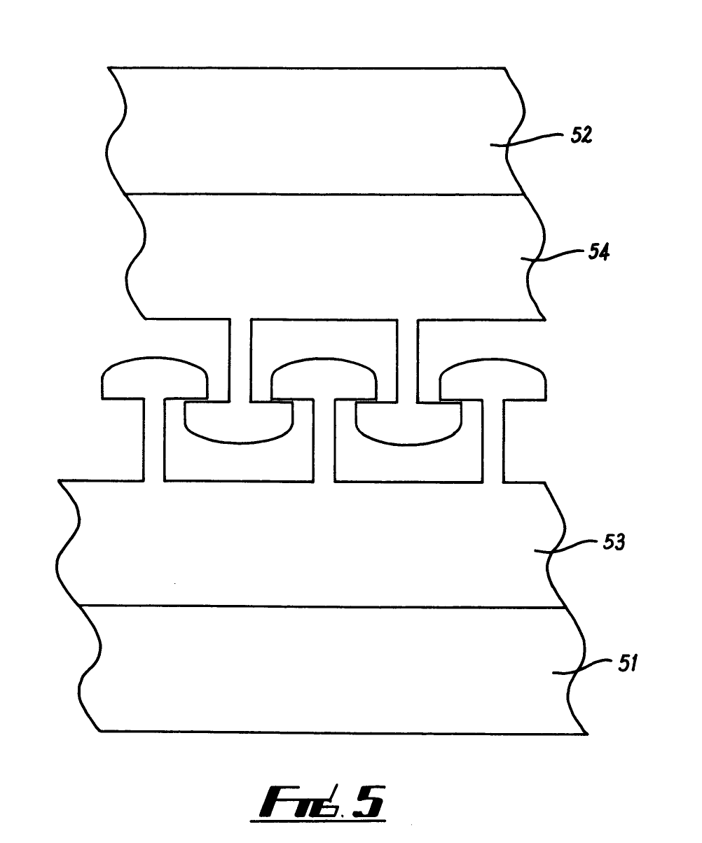

FIG. 5 shows the same fasteners as shown in FIG. 4, but after engagement by pressing together with the user pressing the panel 51 against the side of the truck trailer 52, thereby pushing the fastener attached to the panel 53 into interlocking engagement with the fastener 54 attached to the truck trailer.

In the preferred embodiment 3M™ Dual Lock™ reclosable fasteners are used on both the truck trailer and the advertising panel. The 3M™ Dual Lock™ fastener is constructed of polypropylene and has an acrylic adhesive and a liner applied to the opposite side of the substrate to the protruding stems.

This type of fastener has several advantages. The fastener is low profile and is not obtrusive from the side of the truck trailer or the advertising panel. It is flexible, allowing attachment to flexible curtains on the side of a truck trailer and allowing the advertising panel to be rolled up after having the fastener attached. Two fasteners will reclosably interlock when one is oriented within the full 360° in the plane of the substrates with respect to another fastener. When engaged, disengagement by sheer force is equal in perpendicular directions to the plane of the attached substrates. The fasteners will reclosably interlock with an audible snap to indicate to the worker that the advertising panel is successfully attached to the truck trailer.

When installing an advertising panel, the worker can apply the same fastener to both the panel and the side of the truck trailer without, for example, a male and a female fastener being needed and a convention being needed to decide which type of fastener to apply to the advertising panel. The flexible nature of the fastener allows it to wrap around the contour of non-planar vehicle surfaces. Engaging the fasteners can be achieved simply by pressing perpendicularly to the plane of the surface of the vehicle and the fasteners may be disengaged simply by pulling the advertising panel perpendicular to the plane of the surface of the vehicle. The intimate nature and low profile of the reclosable interlocking fasteners presents a low area at its edge that is resistant to the ingress of liquids when the panel is being cleaned, and air when the truck is being driven, thereby preventing flapping and billowing of the panel during vehicle motion.

In general, it is desirable to have a continuous strip of fastening material around the entire perimeter of the panel and vehicle surface. This will resist ingress of water and air, and help maintain a secure fastening. However, it some circumstances it may be desirable to provide functional breaks in the fastening material.

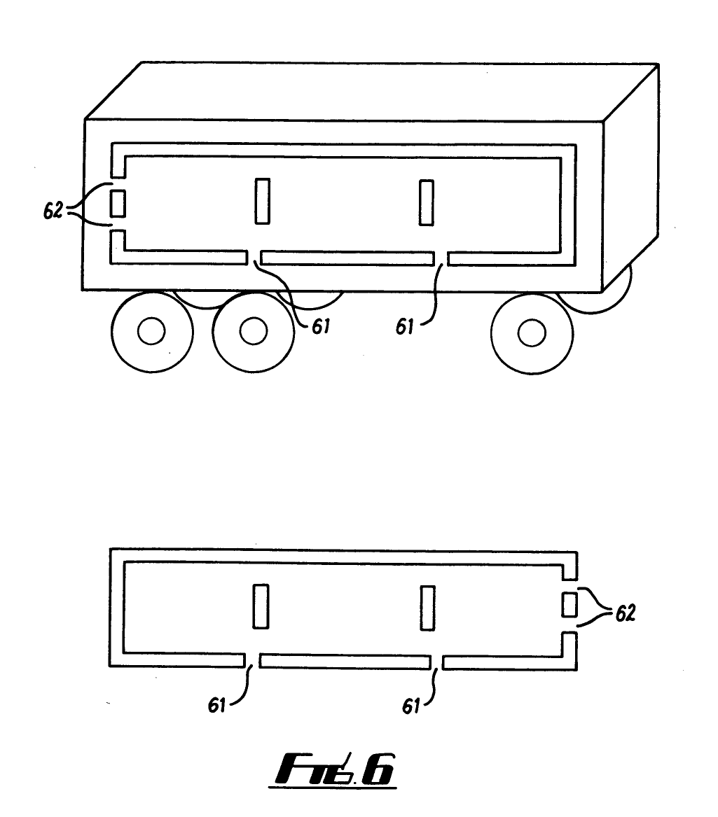

FIG. 6 shows an alternative embodiment of the invention being provided with a number of strategically placed outlets 61, 62. These outlets are in fact breaks formed in the fastener strips 12 provided on the vehicle. Breaks are also provided at corresponding locations of the strips 16 on the panel.

The outlets 61 are provided in the fastening material adjacent the downward facing edge of the vehicle and panel. These outlets are spaced approximately one third and two thirds along the total length of the fastener material, and are, for example, approximately 100 mm long. The outlets 61 allow drainage of any liquid, such as rainwater, that has entered the region between the vehicle surface and the inner surface of the panel.

The outlets 62 are provided in the fasteners adjacent the rearward facing edge of the vehicle and panel. The outlets 62 are spaced approximately one third and two thirds along the total height of the fastener material, and are, for example, approximately 25 mm long. These outlets function as exhaust ports for any air that as entered the region between the vehicle surface and the inner surface of the panel through the fastening material or elsewhere.

Air build-up between the panel and the vehicle has a tendency to raise the panel from the vehicle surface, which may result in billowing or flapping. Water build-up potentially causes similar problems around the lower edge of the panel. Ultimately, this can cause damage to the panel or vehicle, and loosening of the fastening strips. In addition, the image applied to the panel could be distorted. Furthermore, the presence of water between the panel and the vehicle may cause difficulties when removing the panel, due to surface tension effects. Although the fastening material used with the invention is likely to mitigate air and water ingress, it may still occur in certain conditions. The outlets 61, 62 prevent undesirable trapping of liquid and air between the panel and the vehicle surface, should any liquid or air penetrate the fastening material.

It will be evident that the outlets could be located in alternative positions, or could constitute more than a simple break in the fastener. For example, the outlet may be a moulded plastic channel.

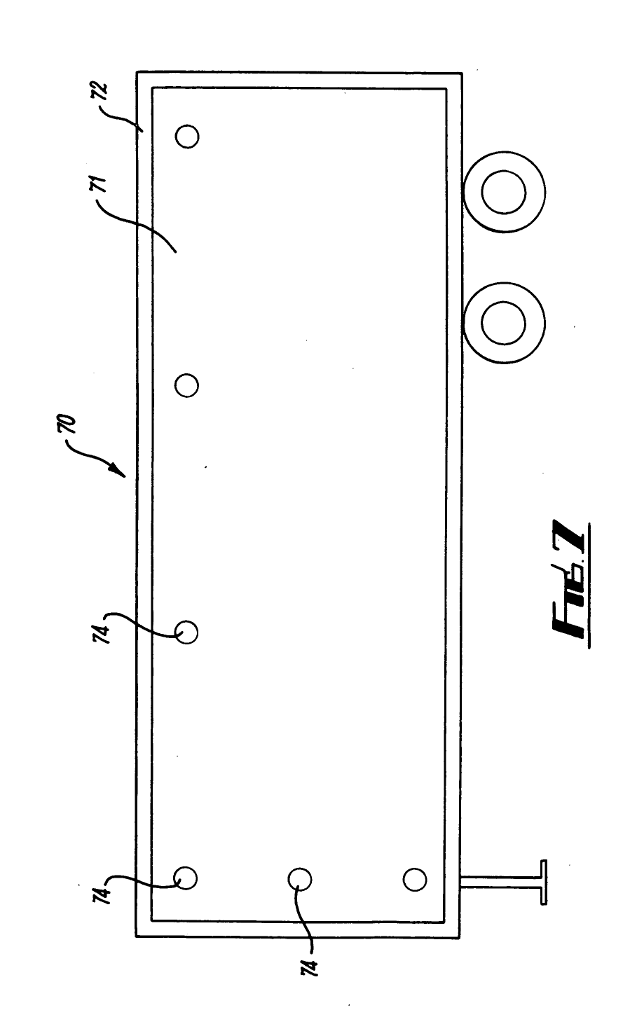

FIG. 7 shows a side view of a vehicle and panel assembly according to a further embodiment of the invention, including an alternative supplementary fastening arrangement.

The system, generally depicted at 70, includes a panel 71 attached to the surface 72 of a vehicle trailer. The panel 71 comprises a non-permeable sheet, similar to the sheet described with reference to FIG. 1. In accordance with the embodiments of FIGS. 1, 3, 4 and 5, the reverse side of the sheet has strips of a fastener attached. The strips are attached around substantially the entire perimeter of the sheet. As before, the preferred fastener is 3M™ Dual-lock™ reclosable fastener.

The assembly includes a supplementary fastener arrangement in the form of a plurality of fastening devices 74. The fastening devices 74 in the examples shown are spatially separated in an area along the upper edge of the panel, and spatially separated along the leading edge of the panel. A part of the fastening element is visible from the outer surface.

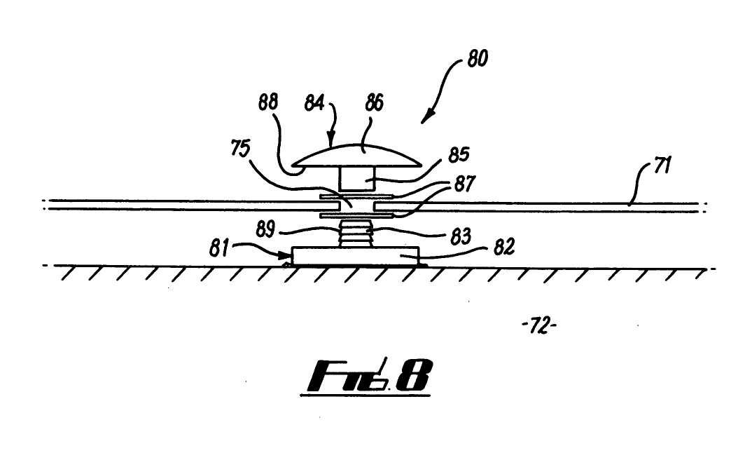

Details of the fastening elements are more clearly shown in FIG. 8, which is a sectional, exploded view through the fastening element and panel.

The fastening device, generally depicted at 80, includes a first member 81 and a retaining member 84. The first member 81 comprises a base portion 82 having a substantially planar surface for fixing to the surface of the vehicle 72. In this embodiment, the base 82 is bonded to the surface of the vehicle by a GHB adhesive.

The first member also includes a protruding stem extending in an axial direction of the first member. The stem 83 functions to engage with the retaining member 84.

The retaining member 84 comprises a formation in the form of a socket 85 and a cap 86 defining an inner surface 88 for abutting the outer surface of the vinyl sheet in use. The socket 85 extends axially from the retaining member.

In use, the fastening device extends through an aperture 75 in the panel. In this example, the socket 85 receives the stem 83, and both extend through the aperture in the panel.

The fastening arrangement is provided with washers 87, located either side of the panel to surround the aperture. Each washer is a planar disc of plastic with an aperture corresponding to the size of the aperture 75 in the panel. The washers function to provide reinforcement to the vinyl panel around the aperture, reducing the likelihood of damage to the panel such as tearing or stretching.

In this example, the washers are disposed on either side of the vinyl panel and abut the panel due to the clamping action of the fastening device. However, in alternative embodiments the washers may be bonded to the vinyl panel.

The fastening device is provided with a locking mechanism. The axial stem 83 is profiled such that a number of radially extending rings 89 are provided on the stem, separated axially along its length. The rings 89 are shaped to form the teeth of a ratchet-type mechanism. Corresponding engaging formations are provided within the socket 85 to provide the pawl of a ratchet-type locking mechanism. The mechanism permits the stem 83 to be received in the socket 85, but prevents its removal by an axial force. The first member and the retaining member are thereby locked together, and the surface 88 provides a retaining force on the sheet 71.

In practice, the first member is initially bonded to the vehicle wall in an appropriate place. The washers and panel are located over the stem, and the retaining element is pushed into engagement with the first member. The radially extending cap 84 provides the retaining surface which abuts the panel.

Typically the panels will be used for a specific advertising campaign and will require removal and replacement after a fixed period of time. Alternatively, a particular panel may be detached for application to another vehicle. The fastening devices of this example are designed for single use, requiring a destructive force to be applied to the fastening device to allow removal of the panel. In this example, the first member and the retaining member are made from a suitable plastic material, and the panel is removed by placing a cutting tool under the cap 86 and cutting through the socket 85 and the stem 83. The panel may then be removed by pulling away from the side of the vehicle to open the reclosable fastener. The cutting of the retaining element prevents its reuse.

In this embodiment, the first portion of the fastening device is also damaged by its removal, and a cutting or slicing tool is used to separate the base portion of the first member from the vehicle surface. On application of another panel, a new first portion is secured to the vehicle surface. However, in another embodiment the fastening device is arranged such that damage, for example cutting, of the retaining member allows the socket of the retaining member to be completely removed from the stem, leaving the stem and first member fully intact and ready to be reused.

The single use attachment system has the advantage that it prevents reuse of one or more components which may have degraded or deteriorated over a previous period of use. In addition, monitoring of the number of fastening elements used provides a convenient way of logging the number of times panels have been applied and reapplied to vehicles.

The fastening devices may optionally have a number of additional features. They may be transparent or translucent to reduce the visual impact on a variety of different panel colours. Alternatively they may be of a particular colour selected to match the panel. The retaining members may be patterned, textured, or provided with a logo to enhance their decorative effect.

A variety of locking mechanisms are envisaged. For example, the teeth 89 on the stem may not be continuous about the circumference of the stem. The teeth and pawl may be provided respectively on the socket and stem.

FIG. 7 shows an arrangement in which fastening devices are not provided along the lower or trailing edges of the panel. This may advantageous, but it will be appreciated that the number and position of the fastening elements is not restricted.

The fastening devices may be used in conjunction with any or all of the features described in this specification.

Further modifications and improvements may be added without departing from the scope of the invention herein intended.

What is claimed:

1. A display panel and vehicle assembly, wherein the assembly comprises a first fastener arrangement located around the majority of the perimeter of the panel, and a second fastener arrangement attached to an external surface of the vehicle, the first and second fastener arrangements configured to reclosably interlock with one another in use, and wherein the assembly further comprises a supplementary fastener arrangement having a first member fixed to the external surface of the vehicle, and a retaining member adapted to engage with the first member to retain the panel to the vehicle.

2. The display panel and vehicle assembly as claimed in claim 1 wherein the supplementary fastener arrangement passes through an aperture provided in the panel.

3. The display panel and vehicle assembly as claimed in claim 1 wherein the first member comprises a base having a substantially planar surface fixed to the surface of the vehicle.

4. The display panel and vehicle assembly as claimed in claim 1 wherein the first member is bonded to the surface of the vehicle.

5. The display panel and vehicle assembly as claimed in claim 1 wherein the first member and the retaining member are arranged such that, when locked together, they cannot be separated without damage to at least one of the first member and the retaining member.

6. The display panel and vehicle assembly as claimed in claim 1 wherein the first member and the retaining member comprises a ratchet-type locking mechanism having a plurality of teeth and a pawl.

7. The display panel and vehicle assembly as claimed in claim 2 wherein the first member includes an axial stem adapted to extend through the aperture and engage with the retaining member.

8. The display panel and vehicle assembly as claimed in claim 7 wherein the stem comprises a main stem body profiled to provide a plurality of axially separated engaging formations extending outwardly from the main stem body.

9. The display panel and vehicle assembly as claimed in claim 2 wherein the assembly comprises at least one reinforcing member around a perimeter of the aperture.

10. The display panel and vehicle assembly as claimed in claim 9 wherein the reinforcing member is a washer.

11. The display panel and vehicle assembly as claimed in claim 9 wherein the reinforcing member is bonded to the panel.

12. The display panel and vehicle assembly as claimed in claim 9 wherein the panel may be provided with a pair of reinforcing members, located on opposing sides of the panel and arranged to reinforce a single aperture.

13. The display panel and vehicle assembly as claimed in claim 1 wherein the supplementary fastening element is a single-use fastening arrangement.

14. The display panel and vehicle assembly as claimed in claim 1 wherein the panel comprises a substantially non-permeable flexible sheet.

15. The display panel and vehicle assembly as claimed in claim 1 wherein said first and second fastening elements comprise a substrate and a plurality of periodically spaced stems protruding perpendicularly from the substrate, each stem being symmetrical about the axis perpendicular to the substrate and having a first diameter at the distal end from the substrate greater than a second diameter at the end adjacent to said substrate.

16. A display panel and vehicle assembly, wherein the assembly comprises a first fastener arrangement located around the majority of the perimeter of the panel, and a second fastener arrangement attached to an external surface of the vehicle, the first and second fastener arrangements configured to reclosably interlock with one another in use, and wherein the assembly further comprises a supplementary fastener arrangement adapted to extend through an aperture in the panel, the supplementary fastener arrangement having a first member fixed to the external surface of the vehicle, and a retaining member adapted to engage with the first member by a ratchet-type mechanism to retain the panel with the vehicle.

17. A method of mounting a display panel comprising a substantially non-permeable flexible sheet to a vehicle, the method comprising the steps of:
attaching at least one first fastening element to said flexible sheet around the majority of the perimeter of said flexible sheet;
attaching at least one second fastening element to an external surface of the vehicle, the external surface of the vehicle being oriented substantially in a surface plane;
imparting a force to said first and second fastening elements in a direction substantially perpendicular to the surface plane;
applying a supplementary fastening arrangement, the supplementary fastener arrangement having a first member fixed to the external surface of the vehicle, and a retaining member adapted to engage with the first member to retain the panel to the vehicle.

18. The method as claimed in claim 17 comprising the additional step of arranging said supplementary fastening elements to extend through an aperture in the panel.

19. The method as claimed in claim 18 comprising the additional step of providing reinforcing members around the aperture in the panel.

20. The method as claimed in claim 18 comprising the additional step of locking the first member and retaining member together using a ratchet-type mechanism.
